(19) United States
(12) Patent Application Publication
(10) Pub. No.: US 2026/0341114 A1
(43) Pub. Date: Oct. 29, 2026

(54) Processing of Pull-tab Game Winning Game Pieces

(71) Applicants: Stanislav Konrath, Milwaukee, WI (US); Christopher Trudeau, Milwaukee, WI (US); Robert Deiss, Milwaukee, WI (US)

(72) Inventors: Stanislav Konrath, Milwaukee, WI (US); Christopher Trudeau, Milwaukee, WI (US); Robert Deiss, Milwaukee, WI (US)

(21) Appl. No.: 19/655,234

(22) Filed: Apr. 22, 2026

Related U.S. Application Data
(60) Provisional application No. 63/793,386, filed on Apr. 23, 2025.

(51) Int. Cl. G07F 17/32; G07F 17/26

(52) U.S. Cl. CPC G07F 17/3255; G07F 17/26; G07F 17/3237; G07F 17/329

(57) ABSTRACT

An in-pack chance promotion game piece is redeemed at a machine without a cash dispenser. The machine scans a presented game piece and checks a database to determine whether it is a winning piece. The machine has a printer which generates a machine-readable token, such as a QR code or a bar code, which includes the amount of cash which the user is entitled to from the redemption of game pieces. This token may then be presented by the user to a cashier, for example a bartender, who is equipped with a tablet or other computer having a scanner which can read the token and instruct the cashier to dispense cash. In this case the tablet need only confirm that the token is in the proper format, it need not consider the game piece.

### CROSS REFERENCES TO RELATED APPLICATIONS

This application claims the benefit of priority of U.S. Provisional App. No. 63/793,386, filed Apr. 23, 2025, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to processing of winning game pieces in pull-tab games.

Games of chance can be, but are not limited to, in-pack chance promotions, sweepstakes, or lottery-like in nature. Generally, game pieces are sold to locations in packs, usually of around 4,000. There is a predetermined prize structure, number of winners, and chance of winning each. The pieces are randomized in the pack and dispensed or distributed to customers at a particular location. Pieces sold at one location cannot be redeemed at another location.

In-pack chance promotions are promotional games in which a player receives a playing card or playing ticket (game piece) that gives the player an opportunity to win an instant prize. The in-pack chance promotion differs from a lottery in that the game piece itself has a value component, either through a coupon on the game piece for other goods or through inherently having value such as being a collectible item. The instant win portion of the game serves as a promotional incentive to encourage purchasing or obtaining of the game pieces. Another differentiating component is that it is not necessary to purchase a game piece, as participants may obtain free game pieces, notably by writing in to the promoter and requesting game pieces. Finally, the in-pack chance promotion has a defined end-date, clearly states the odds of winning, and generally requires a promoter to keep track of personal information of winners over a certain amount.

In the past, tickets were both sold to the customers and paid by staff on location. This method is very inefficient and prone to fraud and theft. A primitive solution to address some of these concerns was an automatic dispensing machine to make the process of selling gaming pieces more efficient and to keep better inventory of gaming tickets. As discussed in our U.S. Publication Nos. 2025/0285501 and 2025/0285505, the disclosures of which are incorporated by reference herein, a further innovation was the implementation of the ability to scan these location-specific game pieces on an automatic payout station via a unique computer readable code hidden with the prize combinations on each piece.

What is needed is a convenient and expeditious way of processing winning game pieces.

### SUMMARY OF THE INVENTION

An apparatus for processing in-pack chance promotion game pieces has a computer, a software program, a bill acceptor, a game piece dispenser for the automatic dispensing and redemption of game pieces. The redemption station has a scanner and a printer. The arrangement for the redemption of pack-based, location specific game of chance arrangement has a corresponding database which includes the unique codes of the winning pieces and the corresponding prize values. Each pack has a unique identifier linked to this database. By determining this unique identifier the machine is able to recognize winners from the linked pack. When a game piece is determined to be a winner, the winner may redeem the prize value in the form of a credit for redemption in the form of additional game pieces at the redemption at the redemption station, in the form of cash from a cash dispenser (if the station is equipped with one), or in the form of a printed ticket showing the total value of winnings after the scanning of one or more game pieces, with the printed ticket being redeemed elsewhere, such as by a cashier.

It is an object of the present invention to provide an apparatus and method for determining the winning status of a game piece and dispensing credits for the purchase of additional game pieces or a printed ticket containing the value to be redeemed.

It is a further object of the present invention to provide an arrangement for printing an article with the winning amount to be redeemed.

Further objects, features and advantages of the invention will be apparent from the following detailed description when taken in conjunction with the accompanying drawings.

### BRIEF DESCRIPTION OF THE DRAWINGS

FIG. 1 is a flow chart of the pull-tab game piece redemption process of this invention.

FIG. 2 is a schematic diagram of the apparatus to carry out the process of FIG. 1.

### DESCRIPTION OF THE PREFERRED EMBODIMENTS

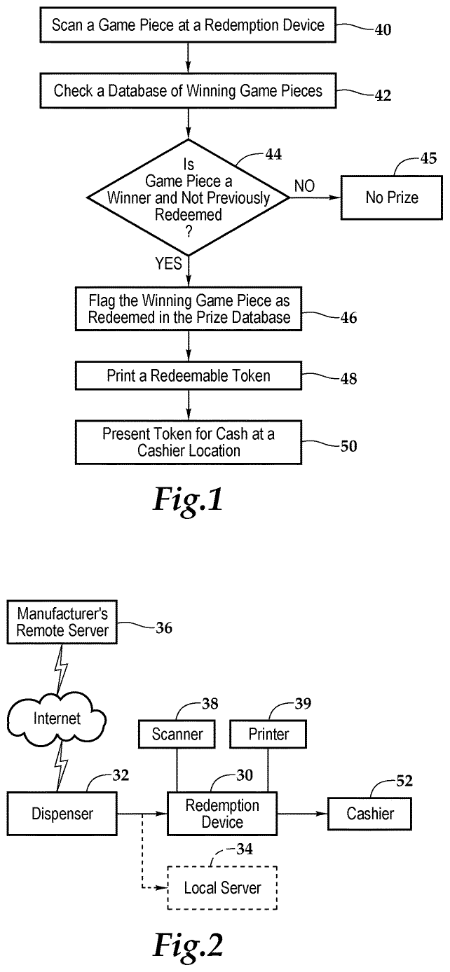

Referring more particularly to FIGS. 1-2, wherein like numbers refer to similar parts, an apparatus 20 dispensing and redeeming winning game pieces in an in-pack chance promotion game is shown in FIG. 2, with the steps involved shown in FIG. 1.

The apparatus 20 includes a pull-tab dispensing machine 22 which includes a computer, a software program, bill acceptor, game piece dispenser(s) for the automatic dispensing and redemption of game pieces in a pack-based, location specific game of chance. Other components that may be included on the apparatus for added functionality include a scanner, a credit card reader, a printer and/or a cash dispenser(s).

Each pack-based, location specific game of chance arrangement has a corresponding database which includes the unique codes of the winning pieces and the corresponding prize values. Each pack has a unique identifier linked to this database. By entering this unique identifier on the pull-tab dispensing machine, the machine is able to recognize winners from the linked pack.

There are multiple ways this database can be recognized by the pull-tab dispensing machine: First, the database of winners may be downloaded from a remote server 36 and stored locally on the pull-tab dispensing machine 22. Second, this database may also be stored on the remote server 36 with the pull-tab dispensing machine contacts this server for every transaction. In a third option, the database is stored on a different local apparatus such as a payout redemption terminal 30 or a local server computer 34. Fourth, information such as the pack serial number, prize amount and or ticket number within the pack may be encrypted using an agreed-upon encryption scheme. The result may be stored in a database to prevent the same ticket from being redeemed twice.

As shown in FIG. 2, if a payout redemption terminal 30 is on site, both it and the pull-tab dispensing machine 32 reference the same database of winner data (whether the database is stored on one of them, on an optional local server 34, on a remote server 36, or some combination of these). If a game piece is redeemed on one, it cannot be redeemed on the other. This may be accomplished by marking off or eliminating a database of codes as they get redeemed, or storing the cryptographic results as discussed above in the fourth option.

A customer can insert cash into the bill acceptor or credit card into the credit card reader (if available) of the pull-tab dispenser 22 to purchase game pieces. If the purchased game piece is a winner, the customer can scan the unique code on the pull-tab dispensing machine 32 to redeem the prize value in the following ways:
1.) Credit to redeem for more game pieces
2.) Cash (if cash dispenser available)
3.) Printed ticket showing total value of winnings (if printer available)
Multiple game tickets can be scanned at one time before being redeemed.

Multiple implementations may be provided. In one implementation, a pull-tab machine that checks its own local database. Alternatively, an apparatus containing a computer, software program, game piece dispenser(s), scanner, and cash dispenser(s) is provided for the automatic dispensing and redemption of game pieces in a pack-based location specific game of chance where the operator can enter a unique identifier on the outside of the pack to download a database of game piece unique identifiers and corresponding prize values to be stored and marked as redeemed locally. The customer can insert cash or electronic payment and receive game pieces from the dispenser. If the customer receives a winning game piece, the unique identifier can be scanned or entered into the apparatus, and the appropriate amount of cash dispensed, or the appropriate amount of credits are added to the dispenser so that the customer can receive additional game pieces. The computer then flags the game piece's unique code as redeemed in the database.

In one embodiment, the pull-tab machine has its own cash dispenser that checks a remote server off-site.

In another embodiment, an apparatus containing a computer, software program, game piece dispenser(s), scanner, and cash dispenser(s) for the automatic dispensing and redemption of game pieces in a pack-based location specific game of chance allows an operator to enter a unique identifier that is associated with the pack, which the software passes to a remote server, along with location-specific information. The remote server links the unique identifier of the pack with the location-specific information. The location-specific information may be an identifier for the game piece processing devices at a particular vendor's location, such as a vending machine, a redemption machine, a verifying tablet or scanner, or any other computer which is part of the system for selling and redeeming the game pieces. The customer may insert cash or electronic payment and receive game pieces from the dispenser. If the customer receives a winning game piece, the unique identifier can be scanned or entered into the apparatus, and the software will contact the remote server with the unique game piece identifier and location-specific information. Upon receiving a response from the server containing confirmation that the unique game piece identifier is a valid code, and that the unique code is an unredeemed code, and that the game piece unique identifier belongs to a pack which is activated for the particular location, the appropriate amount of cash is dispensed, or the appropriate amount of credits are added to the dispenser so that the customer can receive additional game pieces.

The server response could also contain whether the unique identifier is from a pack linked with that location, and the amount to be paid. The machine may then confirm to the server that any particular unique identifier has been successfully redeemed once the transaction is completed.

In another embodiment, the pull-tab machine does not have a cash dispenser, and serves to check game pieces serving as a redemption terminal on-site for prize info. In this method for the dispensing and redemption of game pieces in a pack-based location specific game of chance, game pieces are dispensed from a computer-based dispensing device 32. Unique identifying codes from game pieces are scanned by a scanning device or manually entered on the dispensing device and read into the software on the computer. The software then communicates with another on-site computer-based device containing a database of unique game piece identifiers and corresponding prize values. The communication may be by local WiFi, by the internet, by an offsite server, or by a hard-wired connection. Upon receiving a response from the second computer-based device indicating that the unique code is both valid and not redeemed, the corresponding prize value is added to the dispensing device as credits to be used to purchase more game pieces or a ticket could be printed which contains the value that was redeemed.

Another embodiment involves a pull-tab machine with no cash dispenser as shown in FIG. 1, which checks itself for prize information. In this method for the automatic dispensing and redemption of game pieces in a pack-based location specific game of chance game pieces are dispensed from a computer-based dispensing device, unique identifying codes from game pieces are scanned 40 by a scanning device 38 or manually entered on the dispensing device and read into the software on the computer. The software then checks a local database 42 of unique game piece identifiers and corresponding prize values, and if the unique code is both valid and not redeemed 44, the corresponding prize value is added to the dispensing device as credits to be used to purchase more game pieces. As discussed above, the computer then flags the game piece's unique code as redeemed 46 in the database. If the unique game piece is not on the list of prize values or if it has been previously redeemed, no prize is awarded 45. The local database is loaded as discussed below under the heading “Activating Game Piece Packs”.

This machine, even though it has no cash dispenser, may be provided with a printer 39 which can generate a machine-readable token 48, such as a QR code or a bar code, which includes the amount of cash which the user is entitled to from the redemption of game pieces. This token may then be presented 50 by the user to a cashier 52, for example a bartender, who is equipped with a tablet or other computer having a scanner which can read the token and instruct the cashier to dispense cash. In this case the tablet need only confirm that the token is in the proper format, it need not consider the game piece.

The printer does not necessarily need to generate a machine-readable token. The token could alternatively be a plain text printed information. The purpose of this printer is for the dispenser to do all the work of checking tickets and simply communicate to the employee (through the ticket) what to pay the customer. Such a ticket may or may not be scanned on any device behind the bar. The bartender or employee may keep the ticket to prevent repeated redemption.

In another arrangement, a scanner provides for cashier dispensing of prize amounts. As an alternative to automated cash dispensing apparatus, a human cashier, for example a bartender, may be provided with a tablet or other computer with an attached scanner which is configured to read game pieces. This device is operated only by an employee and is positioned away from customer access, for example behind the bar. The tablet or other computer references a local database which is maintained on another device at the vendor's location, such as at a pull-tab dispensing machine. It confirms from the local database that the game piece is a valid game piece which is activated for that location, the value of the prize, and that the game piece has not been previously redeemed. The tablet or other computer then flags the game piece's unique code as redeemed in the database. The tablet could also store the database in its own memory, a database on a second computer apparatus on site (such as the pull tab dispensing machine), or an off-site database. Alternatively, a pull-tab machine may contain its own cash dispenser and check an additional on-site computer or server that is not the redemption terminal.

A further alternative embodiment is an apparatus containing a computer, software program, game piece dispenser(s), scanner, and cash dispenser(s) for the automatic dispensing and redemption of game pieces in a pack-based location specific game of chance where the operator can enter a unique identifier that is associated with the pack, which the software passes to a server, along with location-specific information. The server links the unique identifier of the pack with the location specific information. The customer can insert cash or electronic payment and receive game pieces from the dispenser. If the customer receives a winning game piece, the unique identifier can be scanned or entered into the apparatus, and the software will contact the server with the unique game piece identifier and location-specific information. Upon receiving a response from the server containing information as to whether the unique code is valid and unredeemed, the appropriate amount of cash is dispensed, or the appropriate amount of credits are added to the dispenser so that the customer can receive additional game pieces.

The server response could also contain:
3. If the unique identifier is from a pack linked with that location
4. The amount to be paid

The machine may then confirm to the server that any particular unique identifier has been successfully redeemed once the transaction is completed.

One of the major challenges for a vendor can be the expense to buy and maintain quality pieces of equipment for both dispensing and redeeming. By combining these two devices, costly components of the equipment such as the computer, scanner, metal case and other elements can be combined, resulting in a significant savings.

### Activating Game Piece Packs

A pack of game pieces is activated by scanning or entering the unique code on the outside of the pack into either the redemption kiosk 30 or the dispensing machine 32. Whichever device is maintaining the local database of location-specific prize data will then download the appropriate prize information linked to the unique code that was entered. Prizes will then be marked off as redeemed as users scan them at either the dispensing machine or redemption kiosk. This method ensures that only game pieces sold on site can be redeemed on site.

Alternatively, the prize data may be stored on a remote server 36. When the unique code from the pack is entered, it will be sent to the server with information identifying the particular location or terminal that it was entered on. The remote server will then store this location information, and all subsequent prize redemption attempts will be checked to ensure that they are originating from the proper location. This will prevent prizes from a pack being redeemed at a different location from the one at which they were sold.

A gaming ticket is scanned on the dispensing machine.
1. If the settings on the game piece dispensing machine dictate that the location-specific prize data is stored on the on-site redemption terminal, it attempts to contact an on-site redemption terminal and the scanned computer readable code is compared against said database. If it is a valid code that has not been marked as redeemed, the corresponding number of credits will be added to the dispensing machine. The user can then use the credits to purchase more gaming pieces. If the game piece dispensing machine is unable to contact the local database on the redemption kiosk, the user will not get credits.
2. If there is no redemption terminal on-site, then the scanned computer readable code is compared against a local database of winners stored on the dispensing machine itself. In this situation, the game piece dispensing machine is equipped with a cash dispenser. If it is a valid code that has not been marked as redeemed, the corresponding number of credits will be added to the dispensing machine. The user can then choose to use the credits to purchase more gaming pieces, or can get the credits dispensed as cash.

In an alternative arrangement, a third computer-based apparatus 34 may be provided on-site that contains the location-specific winner data to be checked by a redemption kiosk and or a gaming piece dispensing terminal.

### Features of Invention

1. Scanner on pull-tab dispensing machine for scanning unique game piece codes and/or unique pack code.
2. Cash dispenser on a pull-tab dispensing machine for immediate redemption of prize-winning game pieces for cash.
3. Conversion of prize winning game pieces into credits for redemption of additional game pieces.
4. A method of multiple redemption apparatuses referencing the same database of winner data, wherein once a winning game piece is redeemed by one apparatus, it cannot be redeemed again on either one.

It is understood that the invention is not limited to the particular construction and arrangement of parts herein illustrated and described, but embraces all such modified forms thereof as come within the scope of the following claims.

I claim:

1. A method of processing a winning game piece in an in-pack chance promotion game, comprising:
scanning a presented game piece in an in-pack chance promotion game at a redemption device to determine a unique code associated with the presented game piece;
causing the redemption device to check a database of winning game piece unique codes to determine whether the presented game piece is a winning game piece;
if the presented game piece is a winning game piece printing a redeemable token with a prize amount; and
presenting the printed token for redemption for cash elsewhere than at the redemption device.

2. The method of claim 1 further comprising after checking the database of wining unique codes flagging the unique code of the presented winning game piece as redeemed in the database of winning unique codes.

3. The method of claim 1 wherein prior to printing a redeemable token, scanning a second presented game piece at the redemption device, and if the second presented game piece is determined to be a winning game piece, adding a second prize amount to the prize amount determined for the previously scanned game piece, and in the step of printing a redeemable token, setting the prize amount to be a combined prize amount including the prize amount and the second prize amount.

4. An apparatus for processing winning game pieces in an in-pack chance promotion game, comprising:
a redemption device having a computer, a scanner and a printer, wherein the redemption device is configured to scan a presented game piece in an in-pack chance promotion game to determine a unique code associated with the presented game piece, and arranged to check a database of winning game piece unique codes to determine whether the presented game piece is a winning game piece, and if the presented game piece is a winning game piece printing on the printer a redeemable token with a prize amount; and
a device remote from the redemption device which recognizes the printed token for redemption for cash.

5. The apparatus of claim 4 wherein the redemption device is configured to, after checking the database of winning unique codes, flag the unique code of the presented winning game piece as redeemed in the database of winning unique codes.

6. The apparatus of claim 4 wherein the redemption device is configured to check the database of winning game piece unique codes on a remote file server.

7. The apparatus of claim 4 wherein the redemption device is configured to scan multiple presented game pieces for associated unique codes, to check the prize-winning status and prize amounts for all the multiple game pieces, and to print the redeemable token with the sum of the combined prize amounts.

8. A method of processing a winning game piece in an in-pack chance promotion game, comprising:
operating a redemption device which has a computer, a scanner and a printer such that presentation of a game piece with a unique code to be scanned by the scanner determines the unique code associated with the presented game piece, and checking a database of winning game piece unique codes stored in a local or remote file server to determine whether the presented game piece is a winning game piece, and if the presented game piece is a winning game piece, the computer operating the printer to print a redeemable token with a prize amount; and
carrying the redeemable token to a location remote from the redemption device and presenting the printed token for redemption for cash.
